(19) United States
(12) Patent Application Publication
(10) Pub. No.: US 2012/0142268 A1
(43) Pub. Date: Jun. 7, 2012

(54) SIGNAL TRANSMISSION METHOD,BASE STATION AND WIRELESS COMMUNICATION DEVICE

(75) Inventors: Ming-Hung Tao, Tainan City (TW); Ying-Chuan Hsiao, Hsinchu County (TW)

(73) Assignee: INDUSTRIAL TECHNOLOGY RESEARCH INSTITUTE, Hsinchu (TW)

(21) Appl. No.: 12/960,557

(22) Filed: Dec. 6, 2010

(51) Int. Cl. H04H 20/71

(52) U.S. Cl. 455/3.05

(57) ABSTRACT

A signal transmission method, and a base station and a wireless communication device using the same station identifier are provided. The signal transmission method is adapted for a M2M device, and includes the following steps. A M2M device is configured as either a follower device or a leader device, and the M2M device is grouped into a M2M device group comprising a leader device and n follower device, where n>=0. Moreover, a M2M contention region is periodically broadcasted in radio frames, where the follower device joins the M2M group by attaching to the leader device in the M2M device group during the M2M contention region. In addition, M2M devices in same M2M device group share same station identifier.

### TECHNICAL FIELD

The disclosure relates to a signal transmission method for machine-to-machine communication, a base station and a wireless communication device using the same.

### BACKGROUND

Machine to Machine (M2M) communication refers to communication technologies that allow both wireless and wired devices to communicate with other devices of the same ability. FIG. 1 illustrates a network architecture of M2M communication. Referring to FIG. 1, a M2M communication network 10 includes a communication network 120, a M2M server 130, a M2M subscriber 140 and a plurality of M2M devices 101, 102, 103, . . . , 10n, where n is a positive integer. For example, referring to FIG. 1, the M2M communication network 10 may use a M2M device 101 (such as a sensor or a meter) to capture an event (such as temperature, inventory level, alarm signal and so forth), which is relayed through the communication network 10 (wireless, wired or a hybrid of wireless and wired communications) to an application server (e.g., the M2M server 130), that translates the captured event into meaningful information (for example, items need to be restocked) to the M2M subscriber 140 user.

Expansion of wireless networks in recent years across the world has made it easier for M2M communication to take place. Accordingly, the amount of power and time necessary for information to be communicated between machines is lessened. These networks also allow an array of new business opportunities and connections between consumers and producers in terms of the products being sold. Recent pilot projects reveal M2M communication also gains traction in a number of new vertical sectors such as health care and logistics. For example, M2M communication allows remote patient monitoring, and M2M communication improves package tracking and distribution of goods from a central distribution centre. The applications for the M2M communication can be, for example, metering, remote control, health care, alarm system, and so forth.

Nowadays, Short Message Service (SMS) has become an increasingly important transmission mechanism for M2M communication, with the ubiquity of GSM and relatively low cost of SMS being cited as advantages. Although SMS has advantages and may be suited as a medium or bearer for M2M communication, several concerns have been raised over reliability of SMS as an M2M channel.

With growth of high speed wireless M2M applications, such as video surveillance, remote information display, and in-vehicle camera systems, high speed wireless communication technologies, such as WiMAX and LTE system, have become inevitable parts of M2M communication solutions. IEEE 802.16m (the advanced WiMAX system), which provides high-speed wireless transmission and large communication coverage, offers a suitable solution for high speed wireless M2M applications. However, current design of IEEE 802.16m mainly focus on human-to-human communication, there are still changes to be made in IEEE 802.16m system so as to meet important requirements of M2M applications, e.g., infrequent transmission, small amount of information, low mobility, sufficient identifiers for huge number of M2M devices, and extreme low power consumption of M2M devices.

Therefore, how to modify current IEEE 802.16m protocol for enabling M2M communications based on the aforementioned important requirements of M2M applications has become a major concern in the industry.

### SUMMARY

According to an exemplary embodiment of the disclosure, a signal transmission method is introduced. The signal transmission method is adapted for a M2M device, and includes following steps. The M2M device is configured to be either a leader device or a follower device. A station identifier (STID) is assigned to a M2M group, wherein the M2M device group includes a leader device and n follower devices, wherein n>=0. A M2M contention region is periodically broadcast in radio frames. Each one of the follower devices joins the M2M group by attaching to the leader device in the M2M device group during the M2M contention region. In addition, all M2M devices in same M2M device group share same station identifier (STID).

According to an exemplary embodiment of the disclosure, a bases station is introduced. The bases station is adapted for M2M communication. The base station is configured for periodically broadcasting a M2M contention region in radio frames. A follower device joins a M2M group by attaching to a leader device in the M2M device group during the M2M contention region.

According to an exemplary embodiment of the disclosure, a follower device is introduced. The follower device is adapted for performing M2M communication. The follower device is configured to be grouped into a M2M device group comprising at least a leader device. In addition, the follower device joins the M2M group by attaching to the leader device in the M2M device group during a M2M contention region in radio frames, and shares same station identifier (STID) with the leader device.

According to an exemplary embodiment of the disclosure, a leader device is introduced. The leader device is adapted for performing M2M communication. The leader device is configured to create a M2M device group comprising at least itself. The leader device receives an attach request from a follower device during a M2M contention region in radio frames, and shares same station identifier (STID) with the follower device.

According to an exemplary embodiment of the disclosure, a wireless communication device is introduced. The wireless communication device is adapted for performing M2M communication. The wireless communication device is configured to be a leader device in a M2M device group, and includes a first timer and a second timer. The first timer is configured for counting a first duration from a connected state to an idle state, where the wireless communication device enters the idle state when the first timer expires. The second timer is configured for counting a second duration from the idle state to the connected state, where the wireless communication device enters the connected state when the second timer expires.

According to an exemplary embodiment of the disclosure, a wireless communication device is introduced. The wireless communication device is adapted for performing M2M communication. The wireless communication device is configured to be a follower device in a M2M device group. The wireless communication device joins the M2M group by attaching to a leader device in the M2M device group during a M2M contention region. The wireless communication device enters an idle state whenever the leader device of the M2M device group enters the idle state. The wireless communication device enters the connected state whenever the leader device enters a connected state.

Several exemplary embodiments accompanied with figures are described in detail below to further describe the disclosure in details.

### BRIEF DESCRIPTION OF THE DRAWINGS

Some embodiments of the present application will now be described more fully hereinafter with reference to the accompanying drawings, in which some, but not all embodiments of the application are shown. Indeed, various embodiments of the application may be embodied in many different forms and should not be construed as limited to the embodiments set forth herein; rather, these embodiments are provided so that this disclosure will satisfy applicable legal requirements. Like reference numerals refer to like elements throughout.

FIG. 1 illustrates a network architecture of M2M communication.

FIG. 2 illustrates a frame structure in IEEE 802.16m standard.

FIG. 3 is a signal flow diagram illustrating procedures required between an AMS and an ABS when an AMS intends to transmit uplink data.

FIG. 4 illustrates a M2M device group of a leader device and a plurality of follower devices.

FIG. 5 is a schematic diagram illustrating a M2M contention region in a frame according to an exemplary embodiment

FIG. 6A is functional block diagram of an advanced base station according to an exemplary embodiment.

FIG. 6B is functional block diagram of an advanced mobile station according to an exemplary embodiment.

FIG. 7 is a signal flow diagram illustrating an attaching procedure of a follower device according to an exemplary embodiment.

FIG. 8 is a schematic diagram illustrating a frame structure according to an exemplary embodiment.

FIG. 9 is a signal flow diagram illustrating procedures required between a M2M device and an ABS when a M2M device intends to transmit uplink data according to an exemplary embodiment.

FIG. 10 is a schematic diagram illustrating an uplink basic assignment

A-MAP information element structure.

FIG. 11 illustrates a time-based state transition diagram of a M2M device according to an exemplary embodiment.

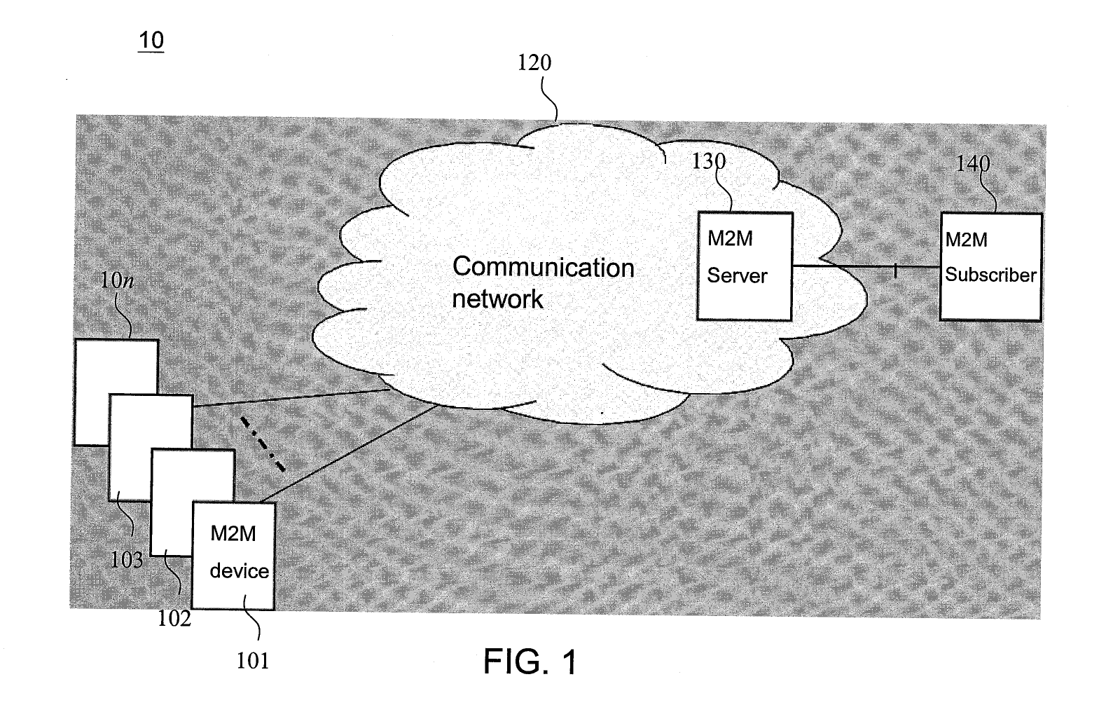

### DETAILED DESCRIPTION OF DISCLOSED EMBODIMENTS

According to exemplary embodiments of the present disclosure, this disclosure provides several modifications to the latest IEEE 802.16m protocol to enable M2M communication based on the important requirements of the M2M applications. This modifications of the IEEE 802.16m standard aim to enable M2M communication in IEEE 802.16m system or similar cellular wireless communication system such as 3GPP LTE system or 3GPP LTE-Advanced system. In addition to enabling M2M communication, the proposed methods in this disclosure also allows IEEE 802.16m protocol meet two of the most important requirements from the M2M applications, one is the number of identifiers should be sufficient enough to support huge number of M2M devices, the other is the power consumption for the M2M device should be extremely low.

In the disclosure, the requirement of the number of identifiers should be sufficient enough to support huge number of M2M devices is generally achieved by a group based feature, a group based policing, and a group based addressing. On the other hand, the requirement of the power consumption for the M2M device should be extremely low is generally achieved by a time controlled method and a time tolerant method.

The basic operations of IEEE 802.16m including a network entry procedure, a downlink data receiving procedure, and an uplink data transmission procedure, are modified in the disclosure for enabling the M2M communication in IEEE 802.16m system while satisfying the requirements of the M2M applications.

The network entry procedure of an IEEE 802.16m mobile station (also termed as Advanced Mobile Station, AMS) is performed whenever the AMS turns on its own power. The network entry procedure of the current IEEE 802.16m standard is briefly introduced below. The AMS firstly scans and downlink-synchronizes with a target cell base station (also termed as Advanced Base Station, ABS), then performs a ranging procedure, a capability negotiation procedure, key exchange, and a registration with the target cell. After completing the registration procedure, the network entry procedure is completed. The AMS thereby obtains a Station Identifier (STID). The STID will be used to identify the AMS during any normal operation taken place between the ABS and the AMS. It is noted that security information is also obtained from the ABS by the AMS during the key exchange procedure.

After network entry, some default flows (connections) listed in Table 1 are automatically established. In IEEE 802.16m system, the Flow Identifier (FID) occupies 4 bits, which means for each AMS, there will be at most 16 flows connected to the serving ABS. Flows with FID=0000 and FID=0001 are both for control connections. A flow with FID=0010 represents a connection that contains just signaling headers, but with no payload. A flow with FID=0011 represents a default service flow (for data connection). Flows with FID=0100-1111 are dynamically established for data communication. Table I also lists corresponding descriptions of the flows.

TABLE I

| Value | Description |
|---|---|
| 0000 | Control FID for unencrypted control connection payload in |
| | the MAC PDU (unicast control FID when PDU is allocated by |
| | unicast assignment A-MAP IE: broadcast control FID when |
| | PDU is allocated by broadcast assignment A-MAP IE) |
| 0001 | Control FID for encrypted control connection payload in |
| | the MAC PDU |
| 0010 | FID for Signalling Header |
| 0011 | FID for transport connection associated with default |
| | service flow (UL and DL) |
| 0100-1111 | FID for transport connection (excluding one for default |
| | service flow) |

Although the present disclosure is introduced with examples based upon IEEE 802.16m standard, general concepts of the disclosure can be applied to IEEE 802.16 system and other wireless multi-carrier systems such as 3GPP long term evolution (LTE) system. Moreover, the term “AMS” can also mean a “mobile station” (MS) or a “user equipment” (UE), and the term “ABS” can also mean a “Base Station” (BS) or a “Node B” or an “enhanced node B” (eNodeB) in other wireless communication systems. In addition, the AMS can be mobile stations such as an electric meter, a water meter, a gas meter, an sensor device, a digital camera device, a mobile phone, a smartphone, a personal computer (PC), a notebook PC, a netbook PC, a digital television, a tablet PC and so fourth.

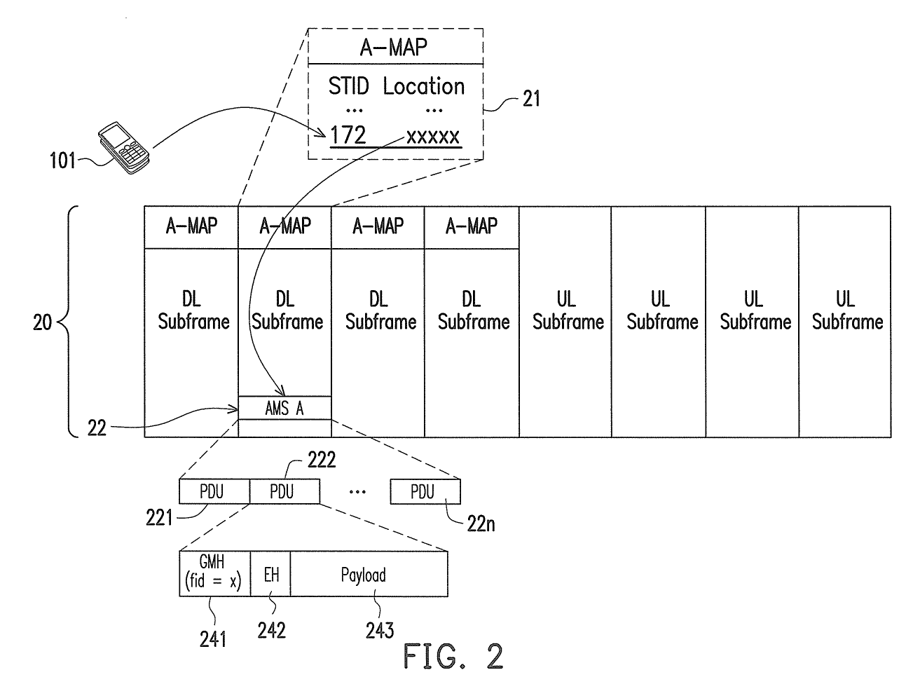

In order to receive downlink data from the ABS, as shown in FIG. 2, the AMS shall keep monitoring the A-MAP (Advanced Medium Access Protocol) in each downlink (DL) subframe. FIG. 2 illustrates frame structure in IEEE 802.16m standard. Each A-MAP of frame 20 describes multiple resource allocations, and each one of the resource allocations includes a STID and the location and size of a resource that is allocated to the STID. For example, referring to FIG. 2, an AMS 101 has been assigned the STID of 172, the A-MAP 21 of an downlink subframe indicates the location of resource unit that is allocated to the STID of 172. After reading the A-MAP 21, the AMS 101 can know if there is any resource unit that is allocated to it in the current DL subframe. If there is resource unit allocated to the AMS 101, the AMS 101 can capture the resource unit such as capturing a resource unit 22 (containing “AMS A”). Next, the AMS 101 can further receive Protocol Data Units (PDUs) encapsulated in the resource unit 22, and process those PDUs. For example, the resource unit 22 includes a plurality of PDUs 221, 222, . . . , 22n. The AMS 101 can process the PDU 222 which includes a generic MAC header (GMH) 241, an extension header (EH) 242, and payload 243. The FID in each PDU is configured for allowing an AMS know to which connection this PDU belongs. In the example shown in FIG. 2, the AMS 101 can know that the PDU 222 is for a connection corresponding to FID=x.

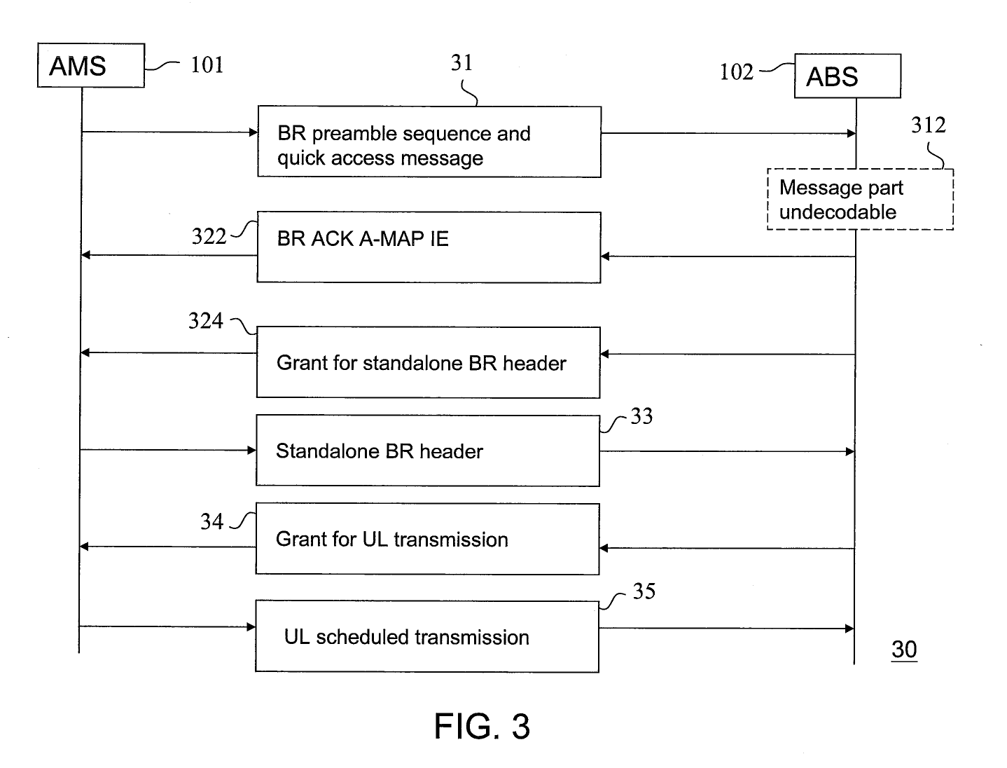

In order to transmit uplink data to an ABS 102, as shown in FIG. 3, the AMS 101 and the ABS 102 shall follow the following procedures as defined in IEEE 802.16m standard. FIG. 3 is a signal flow diagram 30 illustrating procedures required between an AMS and an ABS when an AMS intends to transmit uplink data. The procedures shown in the signal flow diagram 30 also illustrate an uplink data transmission process. At step 31, the AMS 101 generates and transmits a ranging code to the ABS 102 to request a small bandwidth. In particular, the AMS 101 transmits a bandwidth request (BR) preamble sequence and quick access message to the ABS 102. If message part of the ranging code is decidable, step 324 and step 33 may be skipped during the whole procedure illustrated in FIG. 3.

It is assumed that the ABS 102 successfully receives the ranging code and no step in FIG. 3 is skipped, then the ABS 102 can broadcast an acknowledge message, such as a BR ACK A-MAP information element (IE), to announce which range codes are successfully received during the previous frame (step 322). If the AMS 101 discovers that its ranging code is successful received by the ABS 102 after reading the acknowledge message, the AMS 101 shall wait and receive the bandwidth grant message (e.g., a grant for a standalone BR header) sent by the ABS 102 (step 324).

After receiving the bandwidth grant message, the AMS 101 shall utilize the granted bandwidth to send a standalone bandwidth request header including both STID and FID (of the AMS 101) to the ABS 102 to request the bandwidth for a certain connection (step 33).

After receiving the standalone bandwidth request header, the ABS 102 may send another bandwidth grant message (e.g., a grant for UL transmission) including the STID of the AMS 101 to grant the bandwidth requested by the AMS 101 (step 34). Then, the AMS 101 performs an uplink (UL) scheduled transmission using the bandwidth granted by the ABS 102 (step 35).

In the present disclosure, the aforementioned network entry, downlink data transmission and uplink data transmission procedures are modified to accommodate the important requirements of M2M applications. First, M2M devices are grouped according to their functionality and their location. The M2M device here refers to an AMS. A user can configure each one of the M2M devices as a leader device or a follower device in a M2M device group. In other words, each one of the M2M device can be configured as either a leader device or a follower device. The approach of grouping M2M devices into the M2M device group saves station identifiers required for M2M devices.

Also, a M2M device originally configured as a follower device may turn itself to a leader device after a number of times of failed attempting to attach to a nearby leader device. In other words, one of the follower devices can turn itself into a leader device of another M2M device group after failing attaching to any leader device of a M2M device group for a predetermined number of attempts. For example, the number of times of failed attempts for attaching to nearby leader device may be 5. M2M device originally configured as a follower device may also turn itself to a leader device after failing attaching to a nearby leader for a predetermined period. In other words, one of the follower devices turns itself into a leader device of another M2M device group after failing attaching to any leader device of a M2M device group for a predetermined period. For example, the predetermined period is 5 minutes. In the disclosure, there must be one leader device in a M2M device group, and each M2M device group may include a follower device or a plurality of follower devices.

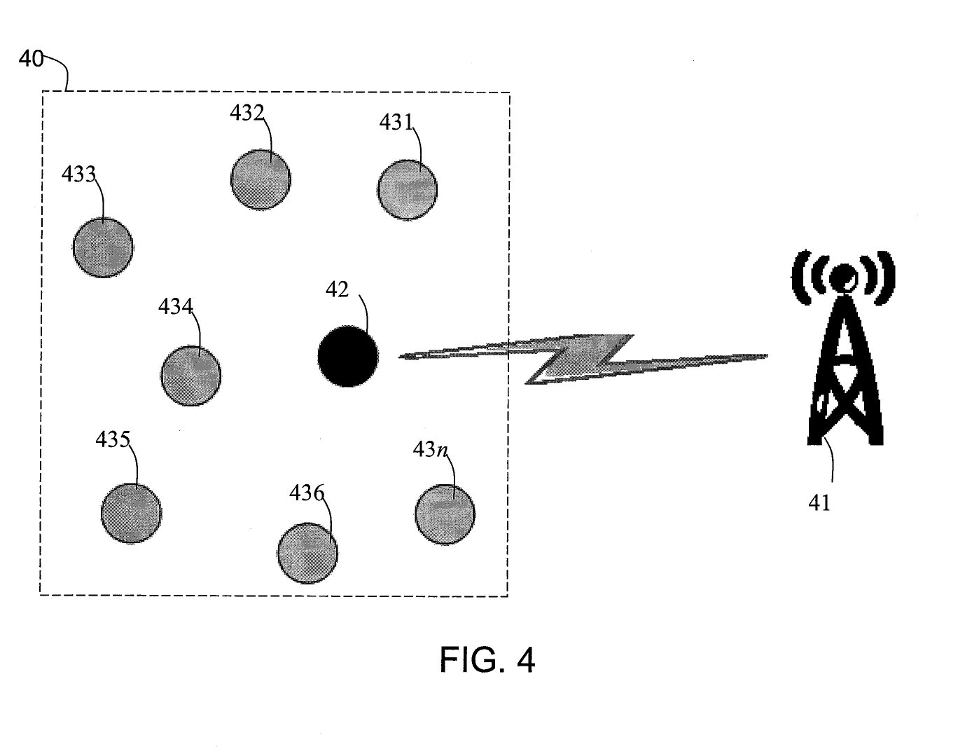

FIG. 4 illustrates a M2M device group of a leader device and a plurality of follower devices. Referring to FIG. 4, a M2M device group 40 includes a leader device 42 and a plurality of follower devices 431, 432, 433, 434, 435, 436, . . . , 43n. In the M2M device group 40 shown in FIG. 4, the leader device 42 is responsible for performing a network entry procedure with IEEE 802.16m base station (such as the ABS 41) and obtaining a STID for the M2M device group 40. In the M2M device group 40, any of the follower devices 431, 432, 433, 434, 435, 436, . . . , 43n does not have to perform the network entry procedure, but still maintains downlink synchronization with the target IEEE 802.16m base station (such as the ABS 41). From another perspectives, a station identifier (STID) is assigned to a M2M device group, where the M2M device group includes a leader device and n follower devices, where n>=0. The disclosure is not limited thereto, and in other exemplary embodiments, there can be just one follower device in a M2M device group or any other number of follower devices in a M2M device group.

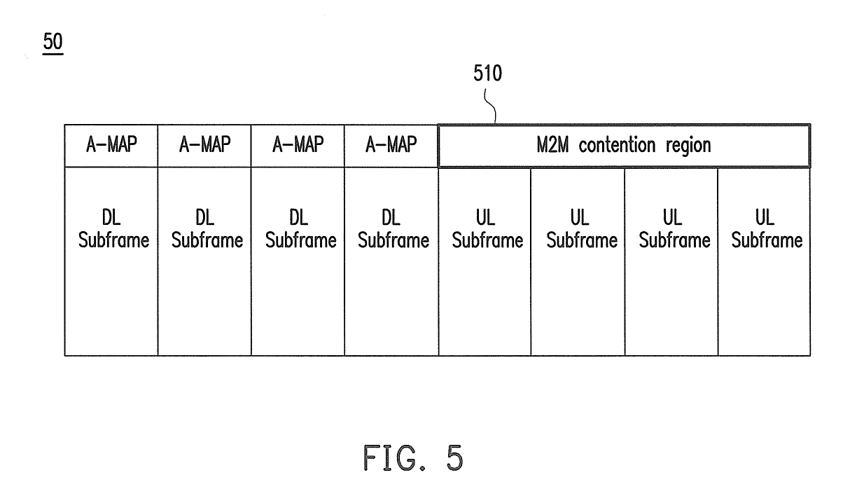

In the disclosure, the IEEE 802.16m frame structure is also slightly modified. There is allocated a M2M contention region in IEEE 802.16m frame. FIG. 5 is a schematic diagram illustrating a M2M contention region 510 in a frame 50 according to an exemplary embodiment. The M2M contention region 510 appears in the uplink subframes, and can be appearing at the top of, in the middle of, or at the bottom of the uplink subframes.

In the present exemplary embodiment, the M2M contention region 510 is allocated by an ABS (such the ABS 41 shown in FIG. 4) to appear periodically for every n frames in the IEEE 802.16m frame structure, as shown in FIG. 5. The parameter n is an IEEE 802.16m system parameter broadcast by the ABS 41, and the value of n can be adjusted dynamically. Also, value of the parameter n can be dependent upon the number of M2M devices within the coverage of the ABS. For example, the ABS 41 can decrease value of the parameter n, after receiving feedback signals from M2M devices, where the feedback signals may report frequency of collisions occurring in the M2M contention region 510 is too high. On the contrary, the ABS 41 can also increase value of the parameter n if no reporting of any collision occurring in the M2M contention region 510 after a predetermined duration.

Moreover, Carrier Sense Multiple Access with Collision Avoidance (CSMA/CA) mechanism is applied in the M2M contention region 510 for the follower devices to attach to a leader device in a M2M device group. In addition, encryption is required for data transmission in the M2M contention region 510. The encryption can be, for example, Data Encryption Standard (DES) or Rivest, Shamir and Adleman (RSA) encryption technology.

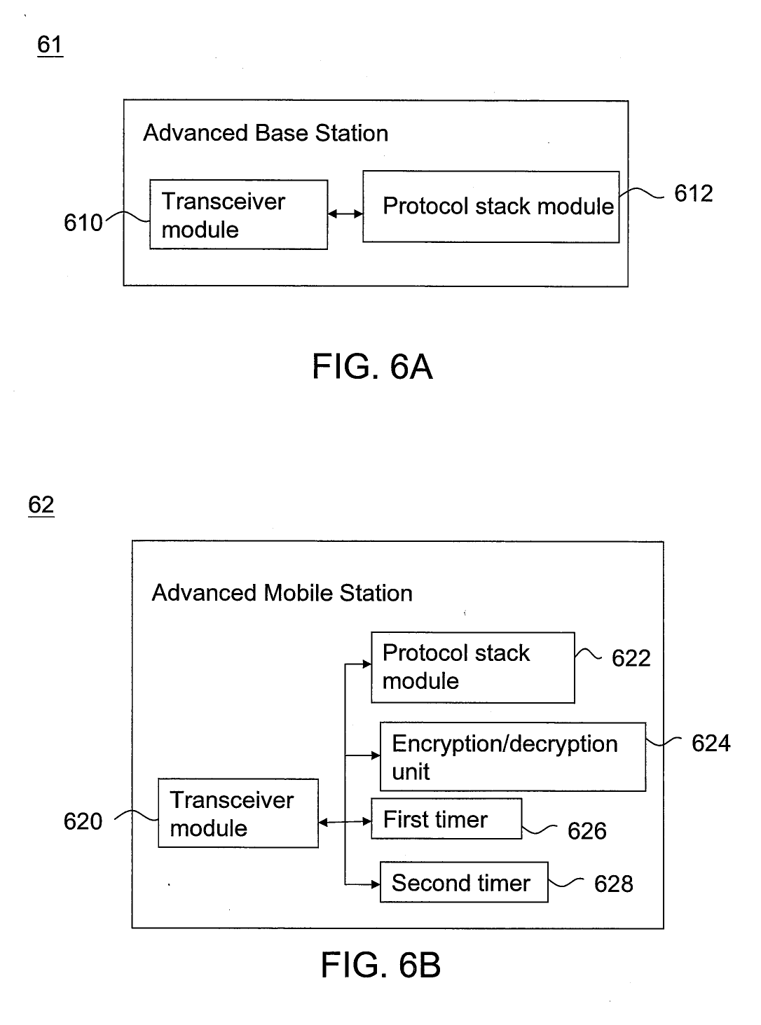

In a M2M device group, an attaching procedure is required for a follower device to attach to a leader device before it can communicate with the serving base station (e.g., an ABS 41). The attaching procedures can take place in the M2M contention region 510. A follower device joins the M2M device group by attaching to the leader device during the M2M contention region. In other words, a base station periodically broadcast a M2M contention region in radio frames, where each one of the follower devices joins the M2M group by attaching to the leader device in the M2M device group during the M2M contention region. Before the attaching procedure is introduced, functional blocks of the ABS 41, the leader device 42, and one of the follower devices are first introduced in accordance with FIG. 6A-FIG. 6B.

FIG. 6A is functional block diagram of an advanced base station (ABS) 61 according to an exemplary embodiment. Referring to FIG. 6A, the ABS 61 includes at least a transceiver module 610 configured for transmitting signals and receiving signals from any AMS. The ABS 61 also includes a protocol stack module 612 configured for processing signals transmitted to any AMS and received from any AMS. In particular, the protocol stack module 612 is configured to process signals related to network entry, uplink data transmission and downlink data transmission according to the modifications made to the IEEE 802.16m standard in the present disclosure. The transceiver module 610 is coupled to an antenna module (not shown) for transmitting signals and receiving signals.

FIG. 6B is functional block diagram of an advanced mobile station (AMS) 62 according to an exemplary embodiment. The AMS 62 can be a leader device or a follower device. The AMS 62 includes at least a transceiver module 620 configured for transmitting signals and receiving signals from an ABS. The AMS 62 also includes a protocol stack module 622 configured for processing signals transmitted to any ABS and received from an ABS. The transceiver module 620 is coupled to an antenna module (not shown) for transmitting signals and receiving signals. The protocol stack module 622 is also configured for monitoring the A-MAP in each downlink subframe broadcast from an ABS, and process signals related to uplink data transmission and attaching procedures.

Furthermore, the AMS 622 includes an encryption/decryption unit 624 configured for encrypting data to be transmitted in the M2M contention region 510 or decrypting data received from the M2M contention region 510.

The AMS 62 also includes a first timer 626 and a second timer 628. The first timer 626 is a connected _to_idle timer, which is configured for counting a first duration from a connected state to an idle state, where the AMS 62 enters the idle state when the connected_to_idle timer expires. On the other hand, the second timer 628 is an idle_to_connected timer, which is configured for counting a second duration from an idle state to a connected state, where the AMS 62 enters the connected state when the second timer expires.

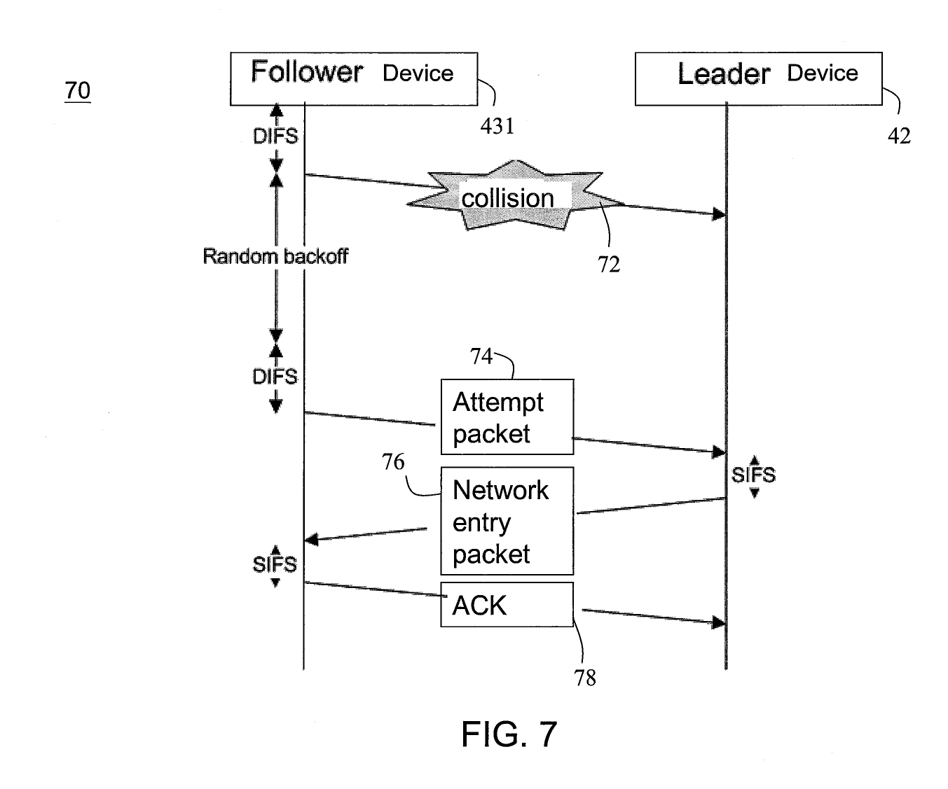

FIG. 7 is a signal flow diagram illustrating an attaching procedure 70 of a follower device according to an exemplary embodiment. The attaching procedure 70 contains the following steps. The follower device 431 and the leader device 42 both have functionalities of the AMS 62. Initially, the follower device 431 is not attached to the leader device 42. At step 74, the follower device 431 attempts to attach to the leader device 42 by sending an attempt packet containing its own device ID or MAC address (through its protocol stack module 622 and the attempt packet is encrypted by the encryption/decryption module 624). The attempt packet can be regarded as an attach request from a M2M device, and the leader device receives the attach request from a M2M device during a M2M contention region in radio frames. The follower device 431 waits for a DCF interframe space (DIFS) period before sending the attempt packet.

If the leader device 42 successfully receives the attempt packet, the leader device 42 can reply a network entry (NE) packet containing the follower device's ID (including its device ID or its MAC address) and network entry information to the follower device 431 at step 76. The network entry information includes, for example, STID, a unique FID, ranging information, and security information. The security information is such as data encryption/decryption information. The network entry information is obtained by the leader device 42 after the leader device 42 completes a network entry procedure with a base station before the attaching procedure 70. In other words, the leader device in the M2M device group sends network entry information to the follower devices after the follower devices attempt to attach to the leader device during the M2M contention region, where the network entry information comprises at least the STID.

Also, the leader device 42 decrypts the attempt packet received from the M2M contention region, and transmits the encrypted NE packet through its own protocol stack module 622 and encryption/decryption unit 624. After receiving the attempt packet, the leader device 42 waits for a Short Interframe Space (SIFS) before transmitting the NE packet.

At step 78, the follower device 431 which successfully receives and descrypts the NE packet can reply an acknowledgement (ACK) packet to the leader device 42 in a SIFS period after the NE packet is received. The follower device 431 executes procedures of the step 78 by its own protocol stack module 622.

The CSMA/CA mechanism adopted in the attaching procedure 70 is similar to that in IEEE 802.11 DCF. In case of the follower device 431 fails attaching to any leader device after a certain number of attempts, the follower device 431 may turn itself into a leader device. For example, the number of attempts can be predetermined as 10 times. Alternatively, the follower device 431 may turn it self into a leader device after failing attaching to any nearby leader device of a M2M device group for a predetermined duration, such as 5 minutes. Also, if a collision occurs when the follower device 431 transmits the attempt packet, such as at step 72, the follower device 431 can attempt to transmit the same attempt packet after waiting for a random backoff period and a DCF period.

Another important characteristic in the present disclosure is group addressing, which is the key for providing sufficient identifiers to a huge number of M2M devices, while knowing that the number of STIDs is limited. The main idea of group addressing is to let the M2M devices belonging to the same M2M device group share the same STID, and differentiate those devices (including a leader device and one or more follower devices) having the same STID by different FIDs. In other words, all M2M devices share same STID of the leader device in same M2M device group, but each one of the M2M devices is differentiated by FID. By sharing the same STID in the M2M device group, the current STID format (size of 12 bits) is not required to be changed. The FID of the follower device is assigned by the leader device during the attaching procedure. The leader device in the M2M device group assigns a unique flow identifier (FID) to each one of the follower devices after the follower devices attempt to attach to the leader device during the M2M contention region. Procedures related to group addressing are executed by respective protocol stack module 622 of the leader device and the follower device.

The leader device and the follower devices belonging to the same M2M device group also share the same control FIDs, and signaling header FID. Therefore, all M2M devices share the same STID and three control FIDs (i.e., FID=0000, 0001, 0010). Each follower device (such as the follower device 431) will obtain a unique FID (the value of the unique FID is selected from the range of “0101” to “1111”) from its leader device, which implies a leader device can be followed by at most 11 follower devices. The unique FID here is a unicast FID for each one of the M2M devices. FID=0100 is assigned to the leader device. Also, the data connection corresponding to FID=0011 is shared by all M2M devices in the M2M device group as a broadcast FID. Therefore, each one of the M2M devices in a M2M device group has to monitor 5 of FIDs simultaneously.

Since there is only one transport FID assigned to each one of the M2M devices, any of the M2M device can have just one transport connection connected to an IEEE 802.16m base station. M2M application has requirements of infrequent data transmission and small amount of information, so one transport HD (connection) is sufficient for each follower device.

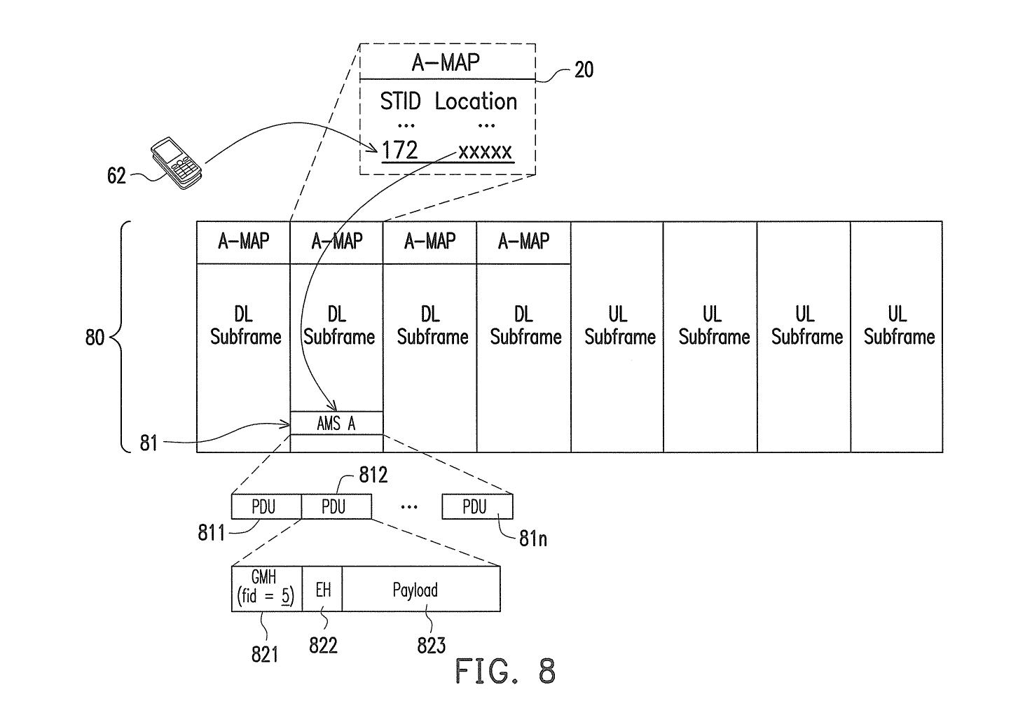

The leader device is responsible for exchanging MAC control messages with the IEEE 802.16m base station, the follower devices can monitor the control messages exchanged between the leader device and base station. By using both STID and FID to distinguish PDUs, the downlink receiving procedure in IEEE 802.16m standard is not modified much in the present disclosure. The downlink data receiving procedure for the M2M device is introduced in accordance with FIG. 8 below.

FIG. 8 is a schematic diagram illustrating a frame structure according to an exemplary embodiment. In the present exemplary embodiment, a frame 80 is similar to a conventional IEEE 802.16m frame 20 as shown in FIG. 2. However, the M2M device (such as the AMS 62) monitors and decodes the frame 80 in a different way. In a downlink data transmission procedure of the M2M devices, both the STID and the FID are used to identify which downlink data the M2M device has to receive. Also, the base station uses a STID and a FID as a unique identifier of the M2M device.

In order to receive data from the base station, the AMS 62 first decodes each A-MAP of the frame 80 to check if there is any resource unit allocated to the STID of its M2M device group. If there is allocated resource unit for the STID of its own M2M device group, the AMS 62 can capture the resource unit, receive the PDUs (Protocol Data Units) 811, 812, . . . , 81n encapsulated in the resource unit. Next, the AMS 62 can further check whether the FID in each of the received PDUs is the FID assigned to itself. The AMS 62 processes only the PDU (such as the PDU 812) whose FID in the GMH 821 is identical to the FID of the AMS 62, or is indicating the PDU is a broadcast or a MAC control PDU. For example, in the example shown in FIG. 8, the AMS 62 is assigned an FID of 5. Therefore, the AMS 62 will process the PDU whose FID is 0,1,2,3, or 5.

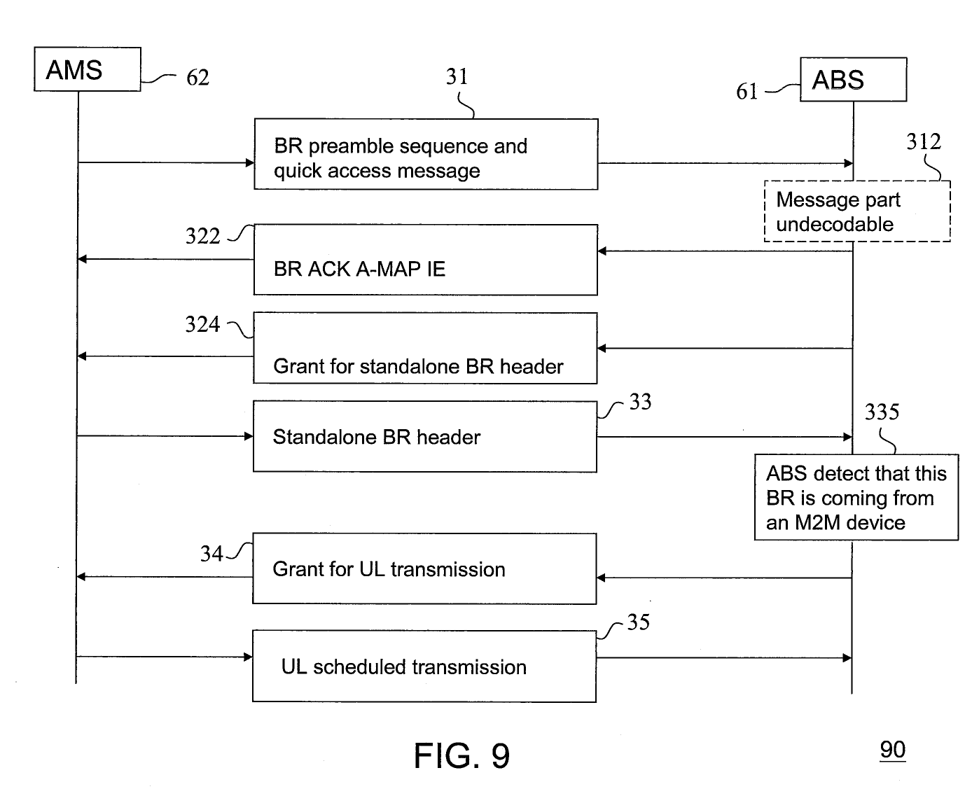

FIG. 9 is a signal flow diagram illustrating procedures required between a M2M device and an ABS when a M2M device intends to transmit uplink data according to an exemplary embodiment. The M2M device in FIG. 9 is, for example, the AMS 62. The UL transmission procedure 90 is also similar to the procedure 30 defined in IEEE 802.16m standard. The only difference is that, before step 34(compared to FIG. 3), the ABS 61 detect that this BR is coming from a M2M device at step 335. At the step 335, the ABS 61 checks if the standalone BR header is coming from a M2M device or from a regular IEEE 802.16m mobile station. From another perspective, the base station detects a bandwidth request for uplink data transmission in uplink data transmission procedure, when the bandwidth request is from a M2M device.

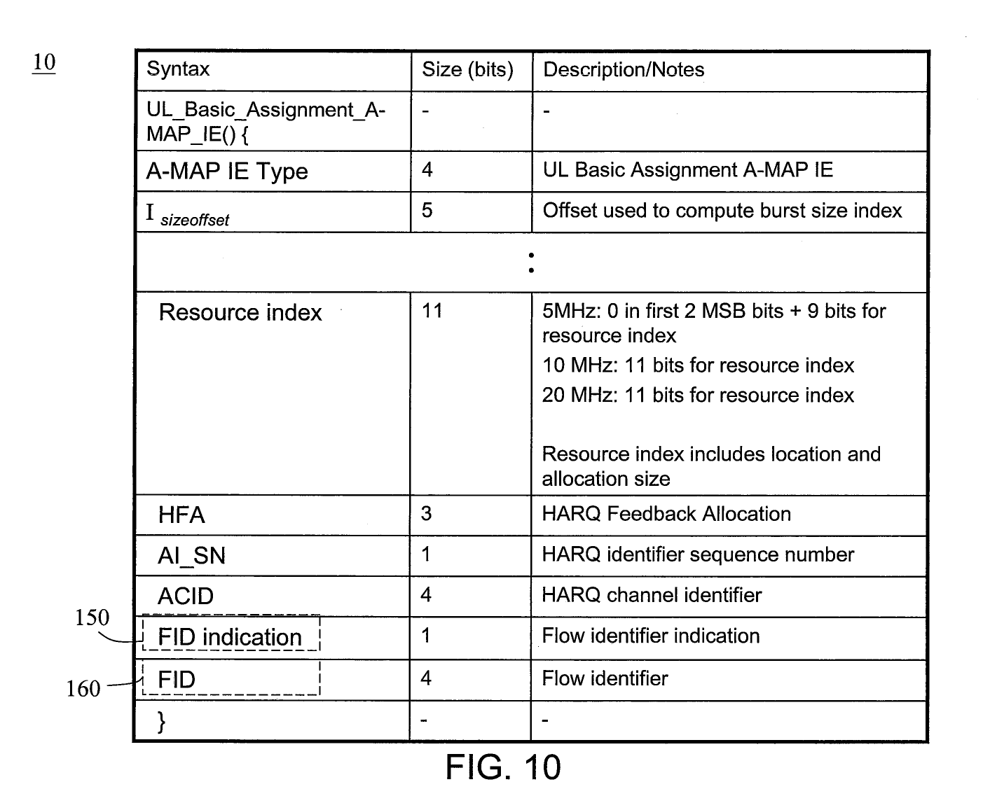

Referring to FIG. 9, if the standalone BR is coming from a M2M device, the ABS 61 can send the M2M device a bandwidth grant message (UL basic assignment A-MAP IE) including not only STID, but also FID of the M2M device. In other words, the ABS 61 uses both a device identifier (i.e., STID) and a connection identifier (i.e., FID) to identify a M2M device. The M2M device also uses both the STID and the FID to identify which uplink transmission opportunity it has been granted by the ABS 61. Also, there would be two additional parameters being added into the original bandwidth grant message: “FID indication” and “FID”. The two additional parameters are introduced below in accordance with FIG. 10.

The M2M device sends a bandwidth request for the uplink data transmission. Also, in uplink data transmission procedure, when the base station detects a bandwidth request for the uplink data transmission is from a M2M device, the base station sets a FID indication to be 1 in the uplink resource assignment information, and appends the FID to uplink resource assignment information. In other words, the FID indication and the FID are presented in the uplink resource assignment information, which is received by the M2M device.

FIG. 10 is a schematic diagram illustrating an uplink basic assignment A-MAP information element structure. Referring to FIG. 10, the UL basic assignment A-MAP IE includes elements such as A-MAP IE type, I_{sizeoffset}, Resource index, HFA, AI_SN, ACID, and reserved bit. The UL basic assignment A-MAP IE also includes corresponding size (in bits) and description of the aforementioned elements of the UL basic assignment A-MAP IE. In the UL basic assignment A-MAP IE (of the bandwidth grant message) replied by the ABS 61 to the AMS 62, the ABS 61 changes the reserved bit into an FID indication 150. Moreover, the ABS 61 also makes the FID indication set to 1 if the message is for sending to an M2M device; otherwise it is set to 0. The parameter FID 160 is presented in the bandwidth grant message only when the FID indication 150 is set to 1. In addition, when the FID indication 150 is set to 1, the parameter FID 160 (or a FID field 160) is appended after the FID indication 150. In other words, the FID indication is set to 1, and the FID is appended following the FID indication in the uplink resource assignment information.

The M2M device also uses both the STID and the FID to identify which uplink transmission opportunity it should use to transmit the uplink data.

The signal transmission method proposed in the present disclosure includes the aforementioned network entry procedure done by the leader device of a M2M device group and the ABS, attaching procedure performed by a leader device and follower devices of the M2M device group, an uplink data transmission (to ABS) procedure and a downlink data receiving (from ABS) procedure of all M2M devices in the M2M device group. How to de-attach a follower device is an implementation issue of the leader device. The leader device may release the FID if the owner of the FID has not interacted with the network for a predetermined period.

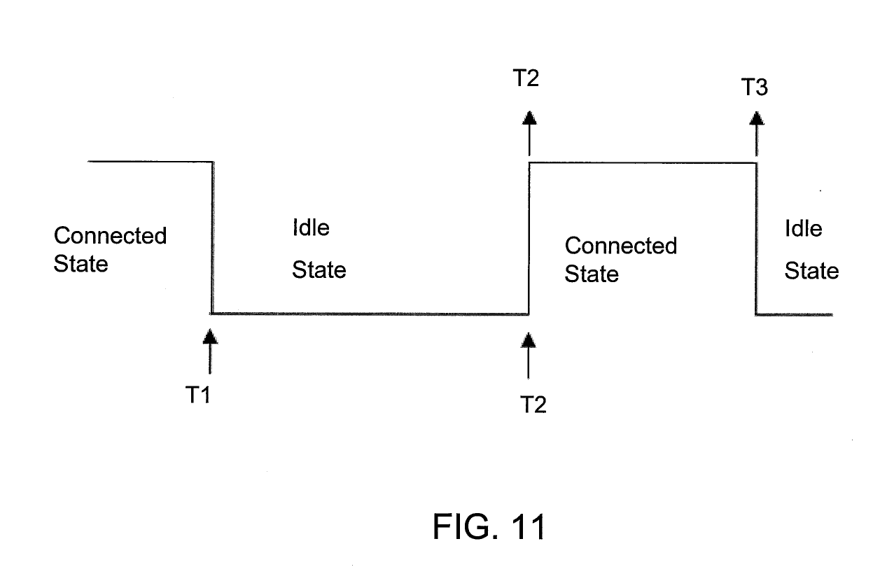

FIG. 11 illustrates a time-based state transition diagram of a M2M device according to an exemplary embodiment. When the M2M device (such as the AMS 62) is operating in an idle state, the AMS 62 is disconnected from the base station (such as the ABS 61) and can turn off most of its hardware modules to save as much power as possible. Therefore, extreme low power consumption can be achieved by forcing the M2M device to enter an idle state periodically. In the present disclosure, all the follower devices in a M2M device group follow the leader device to enter the idle state or leave the idle state. There are 2 timers implemented in the leader device such as the connected to idle timer, and the idle to connected timer. The duration of the connected state is, for example, 5 seconds; the duration of the idle state is, for example, 30 minutes.

When the leader device is operating in the connected state, the connected_to_idle timer starts (such as the timing point T2), as shown in FIG. 11. If the connected_to_idle timer expires (such as the timing point T3), the leader device (such as the AMS 62) starts the idle state negotiation with the ABS 61. When the leader device is operating in the idle state, the idle_to_connected timer starts (from T1). If the idle_to_connected timer expires (at the timing point T2), the leader device performs a network re-entry procedure. The follower devices can monitor the control messages exchanged between the leader device and the ABS 61 to follow the same action taken by the leader device such as the idle state entry or the network re-entry. In other words, whenever the leader device of the same M2M device group enters an idle state, the follower device also enters the idle state; whenever the leader device enters a connected state, the follower device also enters the connected state.

In summary, exemplary embodiments of the disclosure provides a signal transmission method, a base station using the same method, and a wireless communication device using the same method. By grouping M2M devices into a M2M device group, an introduction of attaching procedures of a follower device to a leader device in the M2M device group, group addressing mechanism, an introduction of M2M contention region in uplink frame, modifications of uplink data transmission procedures and downlink data receiving procedures in IEEE 802.16m protocol, the requirements of M2M applications are satisfied.

It will be apparent to those skilled in the art that various modifications and variation can be made to the structure of the disclosed embodiments without departing from the scope or spirit of the disclosure. In view of the foregoing, it is intended that the disclosure cover modifications and variation of this disclosure provided they fall within the scope of the following claims and their equivalents.

What is claimed is:

1. A signal transmission method, adapted for a M2M device, the signal transmission method comprising:
configuring the M2M device as either a leader device or a follower device;
assigning a station identifier (STID) to a M2M device group, wherein the M2M device group comprising a leader device and n follower devices, wherein n>=0; and
periodically broadcasting a M2M contention region in radio frames, wherein each one of the follower devices joins the M2M group by attaching to the leader device in the M2M device group during the M2M contention region.

2. The signal transmission method according to claim 1, the signal transmission method further comprising:
sending, at the leader device in the M2M device group, network entry information to the follower devices after the follower devices attempt to attach to the leader device during the M2M contention region, wherein the network entry information comprises at least the STID.

3. The signal transmission method according to claim 1, the signal transmission method further comprising:
assigning, at the leader device in the M2M device group, a unique flow identifier (FID) to each one of the follower devices after the follower device attempts to attach to the leader device during the M2M contention region.

4. The signal transmission method according to claim 1, wherein one of the follower devices turns itself into a leader device of another M2M device group after failing attaching to any leader device of a M2M device group for a predetermined period.

5. The signal transmission method according to claim 1, wherein one of the follower devices turns itself into a leader device of another M2M device group after failing attaching to any leader device of a M2M device group for a predetermined number of attempts.

6. The signal transmission method according to claim 1, wherein carrier sense multiple access with collision avoidance (CSMA/CA) mechanism is applied in the M2M contention region.

7. The signal transmission method according to claim 1, wherein all M2M devices share same STID of the leader device in same M2M device group.

8. The signal transmission method according to claim 7, wherein the M2M device is differentiated by FID.

9. The signal transmission method according to claim 8, the signal transmission method further comprising:
presenting a flow identifier (FID) indication parameter in uplink resource assignment information; and
detecting, at the base station, a bandwidth request for uplink data transmission in uplink data transmission procedure, when the bandwidth request is from a M2M device.

10. The signal transmission method according to claim 9, wherein, in the uplink resource assignment information, the FID indication is set to 1, and the FID is appended following the FID indication.

11. The signal transmission method according to claim 9, wherein, in downlink data transmission procedure, both the STID and the FID are used to identify which downlink data the M2M device has to receive.

12. A bases station, adapted for M2M communication, wherein, the bases station is configured for periodically broadcasting a M2M contention region in radio frames, wherein a follower device joins a M2M group by attaching to a leader device in the M2M device group during the M2M contention region.

13. The base station according to claim 12, wherein the base station uses a station identifier (STID) and a flow identifier (FID) as a unique identifier of the M2M device.

14. The base station according to claim 12, wherein all M2M devices in same M2M device group share same STID.

15. The base station according to claim 14, wherein each one of the M2M devices in the same M2M device group is differentiated by FID.

16. The base station according to claim 15, wherein, in uplink data transmission procedure, when the base station detects a bandwidth request for the uplink data transmission is from a M2M device, the base station sets a FID indication to be 1 in the uplink resource assignment information, and appends the FID to the uplink resource assignment information.

17. A wireless communication device, adapted for performing M2M communication, wherein,
the wireless communication device is configured to be a follower device; and
the wireless communication device joins the M2M group by attaching to the leader device in the M2M device group during a M2M contention region in radio frames, and shares same station identifier (STID) with the leader device.

18. The wireless communication device according to claim 17, wherein the wireless communication device obtains network entry information from the leader device, wherein the network entry information comprises at least the STID.

19. The wireless communication device according to claim 18, wherein the network entry information further comprises a unique flow identifier (FID) from the leader device.

20. The wireless communication device according to claim 18, wherein the network entry information further comprises security information from the leader device.

21. The wireless communication device according to claim 17, wherein the wireless communication device turns itself into a leader device of another M2M device group after failing attaching to any leader device of a M2M device group for a predetermined period.

22. The wireless communication device according to claim 17, wherein the wireless communication device turns itself into a leader device of another M2M device group after failing attaching to any leader device of a M2M device group for a predetermined number of attempts.

23. The wireless communication device according to claim 17, wherein carrier sense multiple access with collision avoidance (CSMA/CA) mechanism is applied in the M2M contention region.

24. The wireless communication device according to claim 19, wherein the wireless communication device is differentiated by the unique FID.

25. The wireless communication device according to claim 24, wherein,
in uplink data transmission procedure, the wireless communication device sends a bandwidth request for the uplink data transmission; and
the wireless communication device receives uplink resource assignment information comprising a FID indication and the unique FID.

26. The wireless communication device according to claim 25, wherein, in the uplink resource assignment information, the FID indication is set to 1, and the unique FID is appended following the FID indication.

27. The wireless communication device according to claim 24, wherein in downlink data transmission procedure, both the STID and the unique FID are used to identify which downlink data the wireless communication device has to receive.

28. A wireless communication device, adapted for performing M2M communication, wherein,
the wireless communication device is configured to be a leader device; and
the wireless communication device receives an attach request from a M2M device during a M2M contention region in radio frames, and shares the same station identifier (STID) with the attached follower device.

29. The wireless communication device according to claim 28, wherein the wireless communication device obtains network entry information after completing a network entry procedure with a base station.

30. The wireless communication device according to claim 29, wherein the wireless communication device provides network entry information to the at least a follower device, wherein the network entry information comprises at least the STID.

31. The wireless communication device according to claim 30, wherein the network entry information further comprises a unique flow identifier (FID) assigned by the wireless communication device.

32. The wireless communication device according to claim 30, wherein the network entry information further comprises security information from the wireless communication device.

33. The wireless communication device according to claim 28, wherein carrier sense multiple access with collision avoidance (CSMA/CA) mechanism is applied in the M2M contention region.

34. The wireless communication device according to claim 28, wherein the wireless communication device assigns a unique FID to the M2M device which attempts to attach to the wireless communication device.

35. The wireless communication device according to claim 28, wherein,
in uplink data transmission procedure, the wireless communication device sends a bandwidth request for the uplink data transmission; and
the wireless communication device receives uplink resource assignment information comprising a flow identifier (FID) indication and unique FID.

36. The wireless communication device according to claim 28, wherein, in the uplink resource assignment information, the flow identifier (FID) indication is set to 1, and unique FID is appended following the FID indication.

37. The wireless communication device according to claim 28, wherein in downlink data transmission procedure, both the STID and FID are used to identify which downlink data the wireless communication device has to receive.

38. A wireless communication device, adapted for performing M2M communication, wherein the wireless communication device is configured to be a leader device in a M2M device group, the wireless communication device comprising:
a first timer, configured for counting a first duration from a connected state to an idle state, wherein the wireless communication device enters the idle state when the first timer expires; and
a second timer, configured for counting a second duration from the idle state to the connected state, wherein the wireless communication device enters the connected state when the second timer expires.

39. A wireless communication device, adapted for performing M2M communication, wherein,
the wireless communication device joins the M2M group by attaching to a leader device in the M2M device group during a M2M contention region;
the wireless communication device enters an idle state whenever the leader device of the M2M device group enters the idle state; and
the wireless communication device enters the connected state whenever the leader device enters a connected state.
